(19) United States
(12) Patent Application Publication
(10) Pub. No.: US 2011/0279410 A1
(43) Pub. Date: Nov. 17, 2011

(54) TOUCH SCREEN INPUT APPARATUS

(76) Inventors: Sang Hyun Han, Gyeonggi-do (KR); Gi Beom Kim, Seoul (KR)

(21) Appl. No.: 13/142,708

(22) PCT Filed: Feb. 10, 2010
(86) PCT No.: PCT/KR10/00812

§ 371 Date: Jun. 29, 2011

(30) Foreign Application Priority Data
Feb. 13, 2009 (KR) 10-2009-0012106

(51) Int. Cl. G06F 3/045

(52) U.S. Cl. 345/174

(57) ABSTRACT

A touch screen input apparatus includes a first electrode layer, a second electrode layer, and a controller. The first electrode layer is configured to perform sensing in a first direction, and provided with first electrode patterns which are formed on the top surface of a substrate. The second electrode layer is configured to perform sensing in a second direction, provided under the first electrode layer, and provided with second electrode patterns which are formed on the top surface of a substrate such that the second electrode patterns overlap the first electrode patterns through a surface on which the first electrode patterns are not formed, and which are spaced apart from each other by predetermined intervals. The control unit is configured to control the electrode patterns other than electrodes which are used to measure capacitance in a ground state.

### TECHNICAL FIELD

The present invention relates generally to a touch screen input apparatus, and, more particularly, to a touch screen input apparatus which improves an electrode pattern structure, thereby simultaneously realizing noise and cost reductions.

### BACKGROUND ART

Generally, a touch screen refers to a screen equipped with a special input device for receiving a corresponding position at the touch of a hand. That is, the touch screen refers to a screen in which, when an object or the hand of a human comes in contact with a letter displayed on the screen or a specific position without using a keyboard, the corresponding position is detected and input data is directly received via the screen such that specific processing may be performed using stored software.

Such a capacitive touch screen includes a window 10 formed of a transparent material, a touch screen (capacitive sensor) 20 configured to sense the touch of a human body, a controller semiconductor (control unit) 30 configured to drive an electrical signal to a sensor and to calculate coordinates related to the user touch action received via a display based on a change in the electrical signal generated using a sensor, and a display device 40 as shown in FIG. 1.

An electronic apparatus provided with such a touch screen can detect user input corresponding to two or more points (two fingers) at the same time, so that a plurality of points or more touch inputs can be received at the same time as well as a simple one point (one finger) of touch input, thereby having an advantage of being able to be applied to input devices for various types of multiple input command systems, which are implemented using a Graphic User Interface (GUI) as well as a simple one point of user touch input action.

The window 10 is generally made of a transparent plastic material or a transparent glass material which has a thickness of 0.5 mm to 5 mm, and is located in the foreground of a screen including the capacitive sensor 20 and the display device 40.

The capacitive sensor 20 is located under the window 10 and manufactured in such a way that Indium Thin Oxide (ITO) having transparency and electrical conductivity or conductive ink using a polymer material or carbon nanotubes is applied on a transparent material film or a glass substrate, thereby forming an electrode pattern in a specific shape. An ITO material is generally used as a transparent conductive material in the current technology.

With regard to the structure of the capacitive sensor, conductive transparent electrode patterns formed on films (or glass substrates) 22a and 23a, are arranged such that the conductive transparent electrode patterns do not overlap each other, and can detect the change in capacitance in a first axis direction and a second axis direction on the first layer 22b or the second layer 23c as shown in FIG. 2. Otherwise, an electrode pattern of a geometric structure is allocated to detect the change in capacitance in the first axis direction and the second axis direction using only a single transparent conductive electrode pattern layer 22b formed on a single substrate 22a as shown in FIG. 4.

Since such a capacitive sensor device has a vertical structure, a capacitance component, which uses the window or a part including the window and the first layer substrate 22a as a gap (dielectric material/insulating material), is generated between a capacitive medium (generally, the hand of a human and referred to as a first electrode) 25 which comes in contact with the window outside and a transparent conductive electrode pattern area (an electrode, that is, a second electrode) 22b or 22c formed on each of the sensor layers.

An electronic apparatus can detect the occurrence of user touch action itself and the position where the touch action took place in two-dimensional space in such a way as to detect, from among capacitance components generated here, the sizes of the capacitance generated when the respective transparent conductive patterns allocated on the first layer and second layer of the sensor, that is, on the first axis and the second axis, come into contact with a human body or another conductive medium using the sensor controller semiconductor, to calculate the distribution of the capacitance in the two-dimensional space of the first axis and the second axis of the sensor, and to coordinate the two-dimensional location corresponding to the display device of an information apparatus and to output the corresponding coordinates.

A capacitive touch screen device having the above-described structure and operational principle has advantages of having much higher durability against external shocks, scratches, or pollution compared to existing resistive touch screen device, of being capable of detecting various user touch input actions, and providing a clean display screen with excellent optical transmittance.

The prior art capacitive sensor device generally includes the following three types of sensors.

A first type of sensor is manufactured in a layered structure which has two conductive patterns on the whole, as shown in FIG. 2. Each of the first and second layers includes transparent electrode patterns 22b formed in diamond shapes which are connected with each other in a first axis direction and transparent electrode patterns 23b formed in diamond shapes which are connected with each other in a second axis direction, the transparent electrode patterns being sequentially arranged and separated by minimum intervals. The first and second layers perform the function of detecting capacitance in each direction and the change in the capacitance, as shown in FIG. 3.

The first and second layers are manufactured in such a way that the arrangement and sensing direction of each of the transparent conductive patterns of the first layer cross, at a right angle, the arrangement and sensing direction of each of the transparent conductive patterns of the second layer, and that the first and second layers are arranged in the vertical direction as shown in FIG. 2, thereby detecting capacitance in two-dimensional space.

Here, when vertically viewed from the window, the conductive electrode pattern of the first layer and the conductive electrode pattern of the second layer have a vertical/horizontal structure in which arrangement is made such that diamond-shaped electrodes on each layer do not overlap with each other except at the connection points of the diamond shapes, thereby comparatively regularly sensing capacitance, generated by contact being made with a human body on the surface of the window, in the two axial directions.

However, compared with a third type sensor which will be described later, the structure of the first type sensor has a disadvantage in that electrostatic noise, which flows in from the display device 40, the electronic apparatus itself and the front surface of the window, cannot be effectively blocked. Therefore, since the sensor patterns do not include a ground shield film capable of blocking the inflow of external electrostatic noise, the first type of sensor is very poor in the presence of external noise.

A second type of sensor is manufactured as a single layer having only one type of transparent conductive patterns 22b as shown in FIG. 4, and a combination of conductive patterns of triangles or rectangles is generally used to detect all the capacitance components in the first and second directions using only a single layer.

From among the patterns of the transparent conductive electrodes arranged on the first layer, the amount of the change in and the position of generation of the capacitance in the first axis direction can be sensed using electrodes where capacitance, generated by contact being made with a human body of a user, is distributed among square-shaped transparent electrodes.

Meanwhile, from among the patterns of the transparent conductive electrodes arranged on the first layer, the change in and the position of generation of the capacitance in the second axis direction can be sensed using the difference between areas of two facing right triangle-shaped electrodes which are occupied by a human body.

With respect to the application of FIG. 4, generally, when a right triangle-shaped upper electrode group is connected to a single controller control line 27 and a lower electrode group is connected to another single control line 27, there is a problem in that only the difference in human body contact areas generated by a single point (one finger) can be measured in the second axis direction but correct positions cannot be detected in the case of the human bodies of a plurality of users making contact, thereby generating a disadvantage in that multiple user input in a complex form cannot be used.

Meanwhile, when all of the right triangle-shaped upper electrodes and the lower electrodes are separated and then respectively connected to the control lines of the controller, the multiple user input can be sensed but there is a problem in that sensitivity in the second axis direction is remarkably deteriorated.

Further, with regard to the estimation of actual position in the second axis direction, performed using the difference between areas of two facing right triangle-shaped electrodes which are occupied by a human body, it is difficult to measure exact capacitance around the vertex in which the area of a right triangle is very small, that is, around both end points of the right triangles in the second axis direction. In a triangle-shaped transparent electrode, terminating resistance from a part connected to the control line to around a vertex may generally fall in the range of several KΩ to several tens of KΩ. When capacitance is sensed in the vicinity of an end point which is furthest from the part connected to the control line, a value which is much less than actually formed capacitance is sensed, so that there is a problem in that the value of the capacitance generated by actual contact being made with a human body has an asynchronous structure between the part connected to the control line and an end point side.

Further, the concentration distribution of an ITO material which forms a transparent electrode is not constant, with the result that there are many cases where surface resistance (Ω/sgure) is locally non-uniformly distributed, so that it is very difficult to determine the value of a position in the second axis direction of a transparent electrode formed of an ITO material.

Therefore, with regard to an electronic apparatus to which a capacitive touch screen device of that type is applied, there are many cases where a procedure of correcting errors between the value of an actually measured area and the second axis of an actual display device, should be performed at a checking step after completing manufacture and before shipment, so that application is difficult.

Further, there are disadvantages in that sensitivity in one axis direction is excellent but sensitivity in a remaining direction is lowered, in that sensitivity is excellent but resolution for a remaining direction is lowered, in that one more ground layer should be used for a system with much external noise, in that it is disadvantageous for large sized application, in that it is difficult to calculate accurate coordinates because the value of capacitance generated when measurement is performed on both sides of a pattern does not correspond to the coordinates on an actual screen one to one, and in that correction for errors between actually sensed coordinates and a display device requires using a calibration process in the case of production and shipment.

A third type of sensor uses a manner in which a third layer, that is, a transparent conductive ground shield layer 24a and 24b, is applied under the second substrate 23a of FIG. 2 which corresponds to the first type, as shown in FIG. 6.

The ground shield layer has a structure in which a transparent electrode layer 24b is widely disposed on the third substrate 24a of FIG. 6 over almost the entire surface of the substrate as in FIG. 7.

Compared to the first type, this sensor structure has an advantage of effectively blocking electrostatic noise which flows in from the display device 40, the electronic apparatus itself, and the front surface of the window but has a disadvantage of a sensor manufacturing cost or a manufacturing process because a high-priced transparent conductive layer is additionally used.

With regard to the various above-described prior art touch screen input apparatuses, the first type has an advantage in that the number of high-priced transparent conductive film layers can be reduced compared to the third type.

However, the first type does not include a noise shield film layer unlike the three-layered structure, with the result that sensor layers 22b and 23b for detecting capacitance are exposed to the external noise environment as it is, so that there is a disadvantage in that a function of blocking electrostatic noise which flows in from the outside cannot be performed when detecting the change in capacitance generated by contact being made with a human body.

It has been experimentally verified that each of the transparent conductive patterns on the first layer and the second layer generally function as a kind of antenna, so that external noise can be easily flow in, and it has also been verified that a larger amount of noise flows to a pattern structure, when the conductive film patterns of the first and second layers have a longer pattern and greater resistance.

Generally, noise which is generated and flows in from the outside includes the noise of an electronic apparatus system itself which includes a display device close to the bottom of a capacitive sensor, the noise of an inverter stand and an electric motor which flows from the outside of a window (commonly called AC, DC, or R/F noise), and the noise of signal components other than capacitance components that are abandoned from a human body placed in an environment where there is noise.

Therefore, in applications using the first type of sensor, in order to exclude the effect of external noise, a method of finding an arithmetic average in such a way as to repeatedly measure the capacitance and a method of adding a noise removal circuit/software to a controller have been used in order to solve the problems attributable to noise. However, it is difficult to solve the original problem of noise flowing in.

In the case of the second type, since a sensor layer 22b for measuring capacitance is formed of only a single layer, there is an advantage in that the sensor manufacturing cost is the lowest. However, unlike the third type, there is not a noise shield film 24b, so that it is difficult to solve the noise problem like the first type and there are the following additional problems.

Although sensitivity and resolution in one direction are good, sensitivity and resolution in another direction are remarkably deteriorated, with the result that it is difficult to determine an accurate position, so that it is difficult to perform cursive script letter recognition and multiple input operation, which are the main functions of a full touch screen.

Further, when the third type of sensor is mounted on finished-product equipment, there is a problem of certainly setting a corrected value for an error between the output coordinates of a capacitive sensor generated by touch and the actual coordinates of a display with respect to an axis direction having low sensitivity whenever shipping the product.

Therefore, it is generally difficult to perform cursive script letter recognition and multiple input operation, which are the main functions of a touch screen.

Further, in the third type, one more layer, that is, a high-priced conductive layer, is used in addition to the first type structure, with the that three layers are finally used, so that a remarkably larger amount of work is required to manufacture a sensor compared to a sensor which uses one or two layers as well as it is expensive to manufacture a sensor, thereby resulting in low productivity.

The manufacturing cost is high due to a configuration having three conductive layers, the brightness of the screen of a display device is deteriorated due to a configuration having three layers, and the overall production yield (ratio of excellent products) decreases due to increased work processes. Therefore, with regard to the third type, it is necessary to reduce the number of conductive film layers (hereinafter referred to as ITO layers), thereby reducing the cost and increasing production yield.

Therefore, it is necessary to develop a technology which maintains the advantages of the existing touch screen input apparatus and complements various disadvantages.

### DISCLOSURE

### Technical Problem

Accordingly, the present invention has been made keeping in mind the above problems occurring in the prior art, and an object of the present invention is to provide a touch screen input apparatus which solves the problem related to manufacturing cost, the removal of electrostatic noise which flows in from the outside, or the insufficiency of linearity and sensitivity.

Therefore, a touch screen input apparatus according to the present invention has another object of providing a touch screen input apparatus which can be simultaneously applied as means capable of improving a capacitance sensing function and removing external noise in such a way as to change the structure of the electrode patterns of a second electrode layer and a control method of a controller for controlling the conductive electrodes of a first electrode layer and the second electrode layer.

Still another object of the present invention is to provide a structure for first and second electrode patterns which can maximize effect as ground shield films when the first electrode pattern and the second electrode pattern, respectively formed on the first electrode layer and the second electrode layer, do not perform a sensing operation.

### Technical Solution

In order to accomplish the above objects, the present invention provides a touch screen input apparatus, including a first electrode layer configured to perform sensing in a first direction, and provided with first electrode patterns which are formed on the top surface of a substrate; a second electrode layer configured to perform sensing in a second direction, provided under the first electrode layer, and provided with second electrode patterns which are formed on the top surface of a substrate such that the second electrode patterns overlap the first electrode patterns through a surface on which the first electrode patterns are not formed, and which are spaced apart from each other by predetermined intervals; and a control unit configured to control the electrode patterns other than electrodes which are used to measure capacitance, from among the first electrode patterns formed on the first electrode layer configured to sense in the first direction and the second electrode patterns formed on the second electrode layer configured to sense the second direction, in a ground state.

Further, the first electrode patterns are formed such that diamond-shaped electrode patterns are connected in the first direction; and the second electrode patterns are formed in a pole shape such that the second electrode patterns cross the first electrode patterns at right angles, and each of the second electrode patterns are formed to be spaced apart from each other by predetermined intervals.

Further, the first electrode patterns are formed to have an area which is larger than ½ of the entire area of a touch screen.

Further, the separation areas between the first electrode patterns do not overlap the separation areas between the second electrode patterns.

Further, the control unit applies a ground voltage or a specific voltage to electrodes other than electrodes which perform sensing such that the first electrode layer and the second electrode layer function as shield films.

### Advantageous Effects

When the present invention, configured and operated as described above, measures the value of capacitance in such a way as to sequentially apply an electrical signal to the first and second electrode patterns which are formed on the first and second electrode layers, respectively, and used to sense capacitance, the present invention applies ground voltage or specific voltage to all the electrodes of each of the electrode patterns other than electrodes which perform sensing, so that there is an advantage of all the areas of the electrodes other than the electrodes which perform sensing being used as electrostatic shield films for protecting the electrodes which sense capacitance from electrostatic noise applied from the outside.

That is, when the electrode patterns of the first electrode layer perform sensing, some of the electrode patterns of the first electrode layer, which do not perform the sensing, perform a function of shielding electrostatic noise which flows in from the side of sensing electrodes, and the pole-shaped second electrode layer functions as a noise shielding layer in such a way that ground voltage is applied to a sensor sensing area, thereby performing a function of effectively blocking electrostatic noise, abandoned from a display device (Liquid Crystal Device (LCC) or Organic Light Emitting Device (OLED)) placed on the bottom of the second electrodes, in the lower direction. Further, a structure is allowed to perform a function of attenuating noise which flows in from the upper portion due to parasitic capacitance generated because almost the entire area of the first electrode layer which performs sensing is close to that of the second electrode layer to which ground voltage is applied.

Further, when the electrodes of the second electrode layer perform sensing, some of electrodes of the second electrode layer, which do not perform sensing, block noise components which flow in from a side surface. In the case of noise which flows in from a lower display device or an electronic apparatus itself to the electrode patterns of the second electrode layer, the second electrode patterns have small terminating resistance, that is, about 1/10 of the terminating resistance, because of a rectangular pattern structure which is different from the exiting electrode pattern structure (diamond shape), with the result that the terminal intensity of an electrical signal applied to measure capacitance increases and SNR increases 10 times, so that a remarkably small amount of noise flows in, thereby having high workability.

Further, since about ½ of the area of the electrode patterns of the second electrode layer closely overlap those of the electrode patterns of the first upper layer, the parasitic capacitance, between the capacitance sensing electrode patterns of the first electrode layer and the second electrode layer which function as shield films using ground voltage, also functions to attenuate noise which flows in from the outside.

Therefore, electrostatic noise which flows in from the outside can be effectively shielded even though a separate ground shield layer is not provided, so that there are advantages of improving the sensitivity of a capacitance touch sensor, reducing the manufacturing cost, improving productivity based on the simplification of work, and increasing the yield of good products when conducting a final examination.

Therefore, the present invention has excellent advantages of providing a capacitive touch screen input apparatus which may reduce manufacturing cost, being able to shield electrostatic noise, and having excellent linearity and sensitivity, and enabling multiple input.

### DESCRIPTION OF DRAWINGS

FIG. 1 is a schematic view illustrating the state of a general touch screen input apparatus;

FIG. 2 is a cross-sectional view illustrating the structure of a touch screen input apparatus according to an embodiment the prior art;

FIG. 3 is a plan view illustrating the prior art of FIG. 2 in detail;

FIG. 4 is a cross-sectional view illustrating the structure of a touch screen input apparatus according to another embodiment of the prior art;

FIG. 5 is a plan view illustrating the prior art of FIG. 4 in detail;

FIG. 6 is a cross-sectional view illustrating the structure of a touch screen input apparatus according to another further embodiment of the prior art;

FIG. 7 is a plan view illustrating the prior art of FIG. 6 in detail;

FIG. 8 is a cross-sectional view illustrating a touch screen input apparatus according to the present invention;

FIG. 9 is a plan view illustrating the first electrode layer of the touch screen input apparatus according to the present invention;

FIG. 10 is a plan view illustrating the second electrode layer of the touch screen input apparatus according to the present invention;

FIG. 11 is a plan view illustrating a state in which the first and second electrode layers of the touch screen input apparatus according to the present invention are combined;

FIG. 12 is a cross-sectional view illustrating a state in which the capacitance of the touch screen input apparatus according to the present invention is measured;

FIG. 13 is a view illustrating the state of electrodes when sensing is performed in the second axis direction using the first electrode layer of the touch screen input apparatus according to the present invention;

FIG. 14 is a view illustrating the state of sensing in the first axis direction using the second electrode layer of the touch screen input apparatus according to the present invention;

FIG. 15 is a view illustrating a method of detecting the capacitance of the touch screen input apparatus according to the present invention.

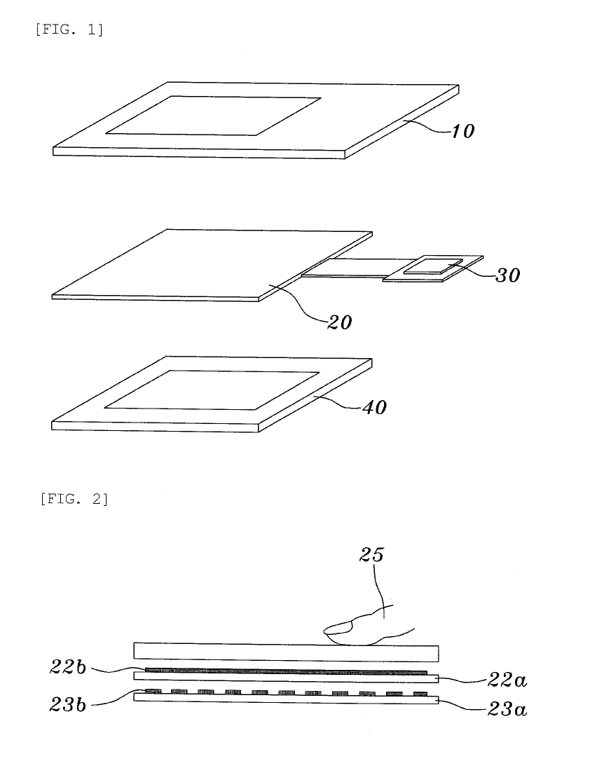

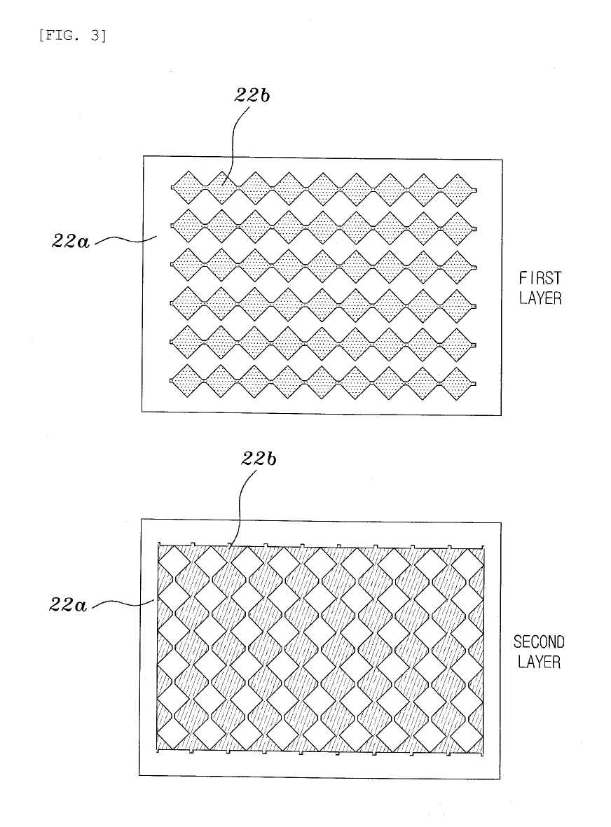

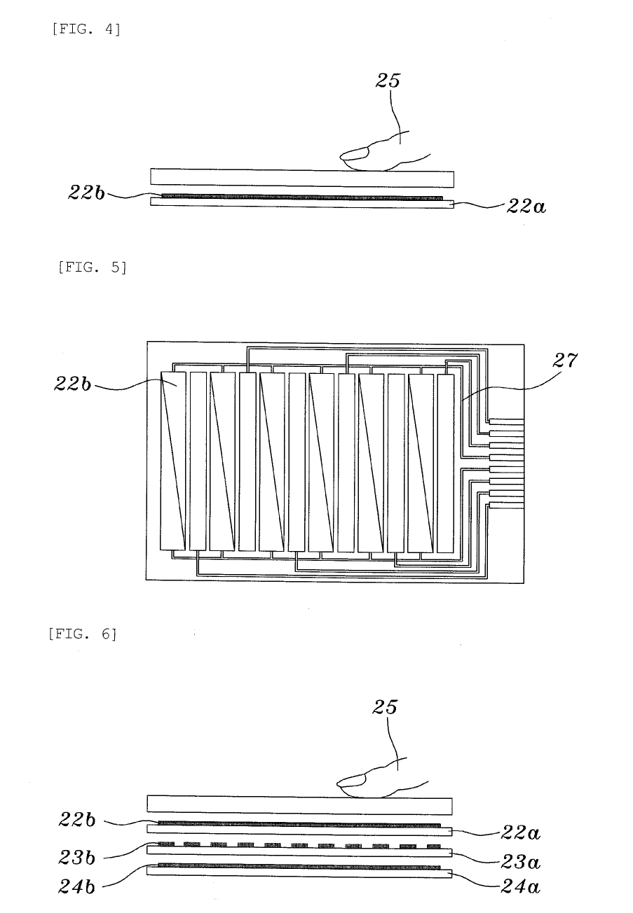

<Description of reference numerals of
principal elements in the drawings>

| | |
|---|---|
| 100: first electrode layer | |
| 110: first electrode pattern | |
| 130: sensing channel | 200: second electrode layer |
| 210: second electrode pattern | |
| 230: interval | 240: sensing channel |
| 300: control unit(IC) | 400: window |

### BEST MODE

### Mode for Invention

Hereinafter, preferred embodiments of a touch screen input apparatus according to the present invention will be described in detail with reference to the attached drawings.

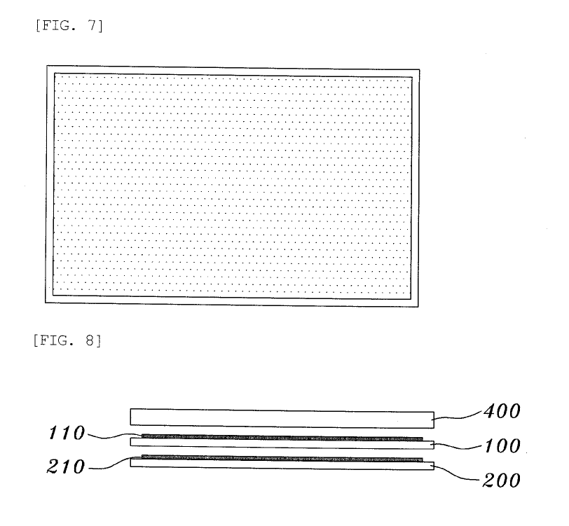

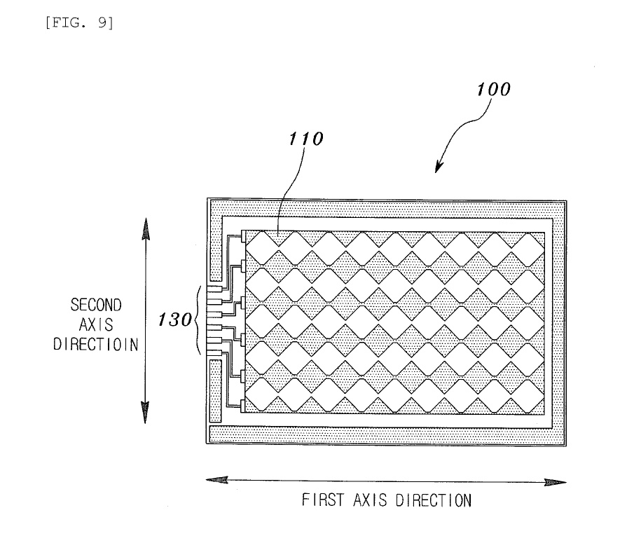

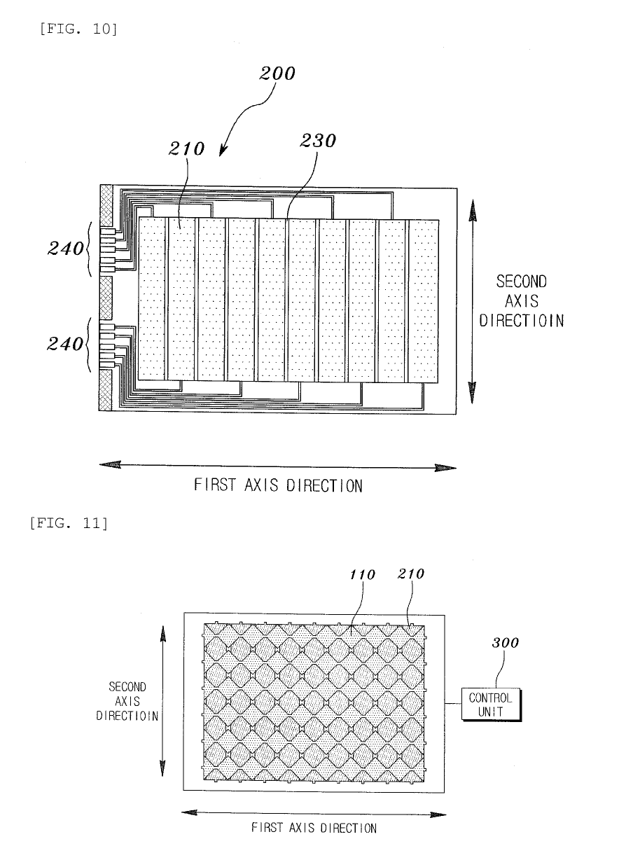

FIG. 8 is a cross-sectional view illustrating a touch screen input apparatus according to the present invention, FIG. 9 is a plan view illustrating the first electrode layer of the touch screen input apparatus according to the present invention, FIG. 10 is a plan view illustrating the second electrode layer of the touch screen input apparatus according to the present invention, and FIG. 11 is a plan view illustrating a state in which the first and second electrode layers of the touch screen input apparatus according to the present invention have been combined.

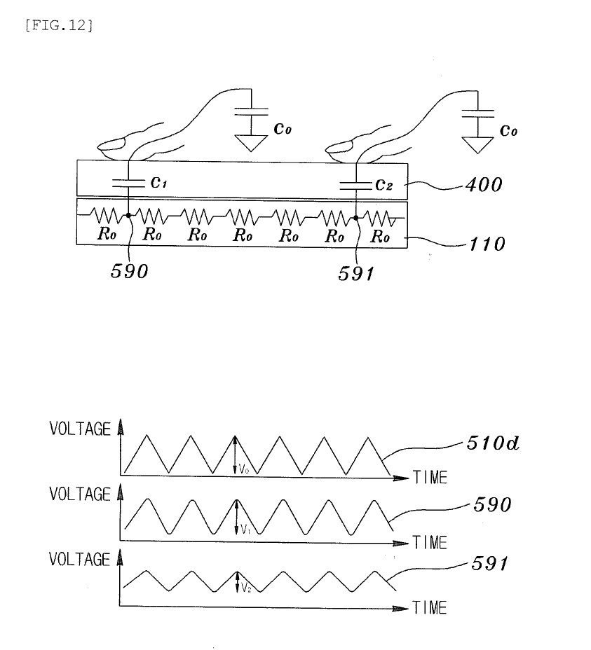

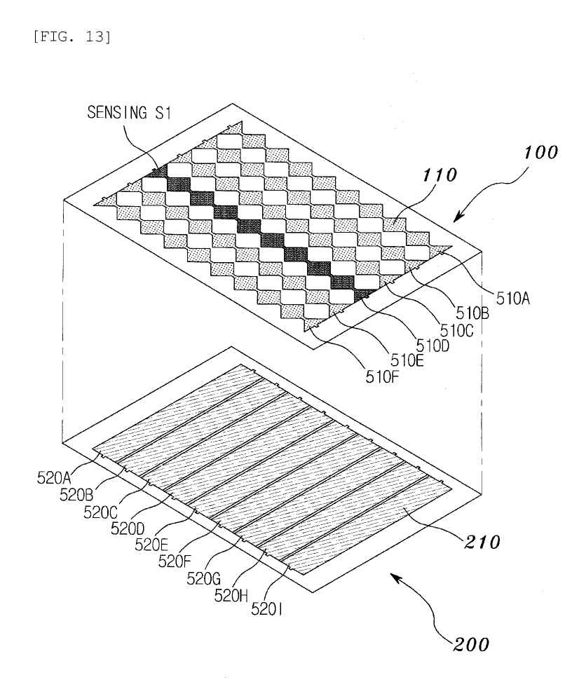

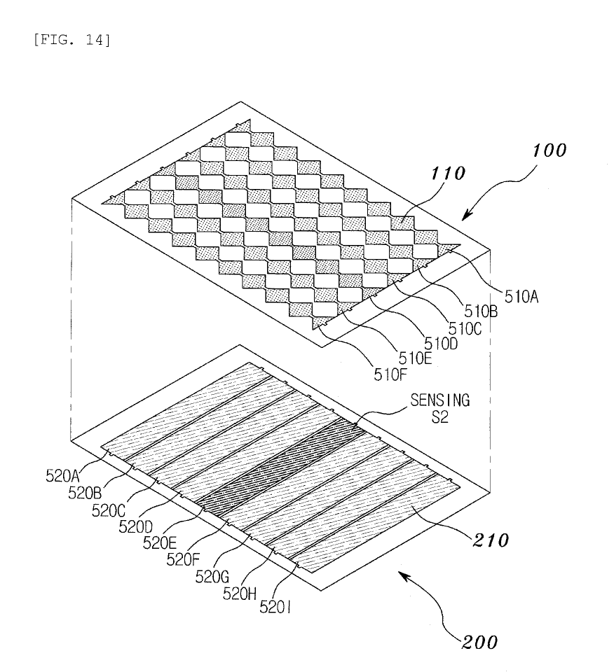

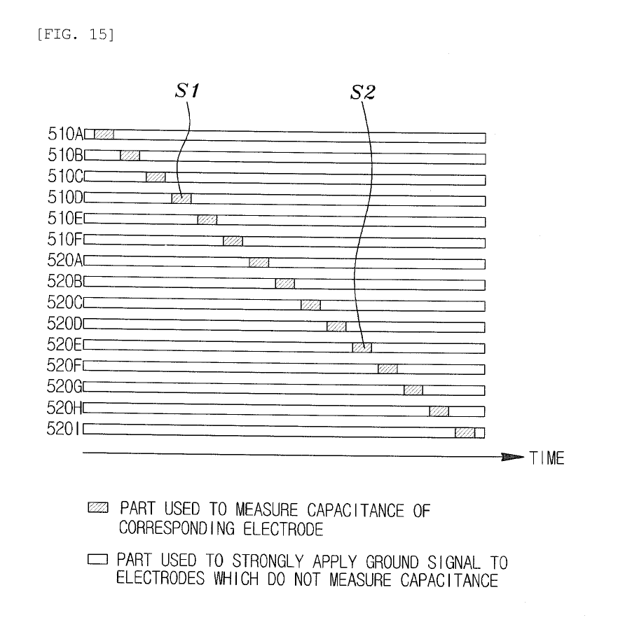

FIG. 12 is a cross-sectional view illustrating a state in which the capacitance of the touch screen input apparatus according to the present invention is measured, FIG. 13 is a view illustrating the state of electrodes when sensing is performed in the second axis direction using the first electrode layer of the touch screen input apparatus according to the present invention, FIG. 14 is a view illustrating the state of sensing in the first axis direction using the second electrode layer of the touch screen input apparatus according to the present invention, and FIG. 15 is a view illustrating a method of detecting the capacitance of the touch screen input apparatus according to the present invention.

A touch screen input apparatus according to the present invention includes a first electrode layer 100 which includes first electrode patterns 110; a second electrode layer 200 which is provided under the first electrode layer and which includes second electrode patterns overlapping the first electrode patterns through a surface on which the first electrode patterns are not formed and being spaced apart from each other by predetermined intervals; and a control unit 300 which controls electrodes other than electrodes which are used to perform sensing on the first electrode layer and the second electrode layer in a ground state.

Before the following description is made, a description will be given of a first electrode layer that is in charge of sensing in a second axis direction and a second electrode layer that is in charge of sensing a first axis direction according to an embodiment of the present invention.

The first electrode layer 100 has a structure in which diamond-shaped first electrode patterns (transparent electrode patterns) 110 connected in the first axis direction are arranged in the second axis direction at minimum intervals. The first electrode layer 100 performs a function of sensing the change in capacitance in the second axis direction. The first electrode patterns 110 patterned on a substrate are gathered on a sensing channel 130 so as to be connected to an external semiconductor for detecting capacitance. Further, the first electrode patterns are separated from each other by predetermined intervals in the second axis direction.

The second electrode layer 200 is used to sense the change in capacitance in the first axis direction, and includes the pole-shaped second electrode patterns 210 arranged in the first axis direction and separated from each other at predetermined intervals 230 according to the technical gist of the present invention.

Here, the predetermined interval 230 is a separation distance which is made to distinguish between electrodes when the first and second electrode patterns 110 and 210 are placed in the second axis direction and the first axis direction, respectively, and means a minimum distance which may be permitted when the second electrode patterns 210 are formed.

The second electrode patterns 210 will be described in greater detail. Long pole-shaped second electrode patterns are arranged in a direction such that the second electrode patterns cross at a right angle to the first electrode patterns 110. Other than at minimum intervals 230 which should be separate apart from each other so as to arrange electrodes and to distinguish between electrodes, electrodes are sequentially formed over the entire area of the patterns of the second electrode layer 200 used to detect capacitance. Although this will be described later, electrodes are formed over the entire area other than the minimum intervals, thereby functioning as a shield film.

Currently, the resistance of an ITO material which is generally used for a touch screen is a level of 300 Ω/sq. When the pole-shaped electrode patterns as in the second electrode layer are applied to an approximately 3-inch-display touch screen which is frequently used for a mobile phone, the terminating resistance between both ends of a conductive electrode falls in the range of about 1.5 KΩ to 4 KΩ. Therefore, the deterioration in detection power attributable to the increase in terminating resistance according to the prior art structure is noticeably reduced, thereby providing an electrode pattern having excellent sensitivity.

Further, an electrical signal applied from the touch screen control unit (semiconductor) 300 in order to measure capacitance may be safely transmitted to a terminal, with the result that a ratio of an electrical driving signal which is used to sense capacitance to electrostatic noise which flows in from the outside, that is, the Signal to Noise Ratio (SNR), increases, thereby having a relatively strong tolerance for noise.

When the first electrode layer and the second electrode layer, which are configured as described above, are overlapped and combined with each other as shown in FIG. 11, arrangement is made such that the first electrode patterns cross at right angles to the second electrode patterns, so that preparation is made such that capacitance of two dimensional space can be detected. Here, the second electrode patterns overlap the first electrode patterns while the second electrode patterns overlap the first electrode layer in areas where the first electrode patterns are not formed.

Here, when the first electrode patterns and the second electrode patterns are vertically viewed from a window 400, arrangement is made such that the diamond-shaped electrodes of the first electrode layer overlap the pole-shaped electrodes of the second electrode layer in a matrix, and the first electrode patterns are configured to occupy area corresponding to 50% of the area occupied by the second electrode patterns. Further, the area of separation between first electrode patterns does not overlap the area of separation between second electrode patterns when the first and second electrode layers overlap each other.

Therefore, in the first electrode layer, the change in capacitance is measured in the direction of the first electrode patterns. In the second electrode layer, the change in capacitance is measured in the parts of the second electrode patterns, which do not overlap the first electrode patterns, in the direction which is perpendicular to the direction of the first electrode patterns.

When measuring the capacitance generated by the human body coming into contact with the surface of the window 400, the first electrode patterns 110 can be used to measure capacitance corresponding to areas occupied by corresponding electrodes regardless of the second electrode patterns. The second electrode patterns 210 can be used to measure capacitance in areas other than the areas where the second electrode patterns overlap the first electrode patterns. Therefore, the first and second electrode patterns have a vertical structure such that capacitance can be comparatively uniformly detected.

Therefore, although the structure of the second electrode layer 200 according to the present invention is different from that of the prior art, performance in which the level is the same as that of the prior art can be shown. In the case of such a second electrode pattern, performance in which the sensing of the capacitance has been improved because of the reduced terminating resistance of the conductive pattern is shown.

Further, in order to implement the capacitance measurement sensitivity of the first electrode layer 100 which is similar to that of the second electrode layer 200, the size of each of the diamond-shaped electrode patterns should be fixed and the thickness of each of connection points should be increased. Therefore, depending on the situation, electrode patterns may be formed such that the sum of the areas of the electrode patterns of the first electrode layer 100 is larger than one to two of a display area which should be detected. However, when electrode patterns are formed in too many areas, it should be noted that the area in which the second electrode layer is exposed to the window 400, which is a touch screen area placed on the first electrode layer, is reduced, so that the capacitance sensing ability of the second electrode layer deteriorates.

Meanwhile, although the direction and structure of patterns of the first electrode layer for performing detection in the second axis direction and the second electrode layer for performing detection in the first axis direction have been described in the present invention, these are merely embodiments. Those skilled in the art may easily implement changes in the sensing directions in such a way as to change the directions of the diamond-shaped first electrode pattern and the pole-shaped second electrode pattern.

Next, the resistance and capacitance sensing ability of the first electrode pattern will be described.

Generally, the resistance of an ITO material currently corresponds to a surface resistance of about several tens to several thousand of Ω/sq. The resistance of an ITO material which is currently used in touch screens corresponds to a about 300 Ω/sq. When diamond-shaped electrodes as in the first electrode pattern are applied to an approximately 3-inch-display touch screen input apparatus which is frequently used in mobile phones, the terminating resistance between the both ends of a conductive electrode falls in the range of about 10KΩ to 40KΩ depending on the size of the diamond pattern and the thickness of the connection point thereof.

Therefore, when an electrical signal used to measure capacitance is applied from the control unit 300 to the sensing electrode pattern of the first electrode layer, a structure as in a kind of low pass filter (low pass filter having a R-C structure) having a structure, such as R0*N (where R0 is symbolized resistance and N is a symbolized integral number), C1+C0, or C2+C0, may be generated, as shown in FIG. 12, based on the combination of the resistance of the first electrode pattern 110 and the capacitance generated by contact being made with a human body.

C1 and C2 are values which each symbolizes the capacitance generated between each of electrode patterns used to sense capacitance and the window 400. C0 is a value which symbolizes the capacitance generated between the window and a virtual ground through a human body. Such a structure of a low pass filter attenuates the width of an electrical signal applied from the controller for charging/discharging in order to measure the capacitance components of a sensor using a factor generated when resistance of a conductive pattern used to sense capacitance increases. The attenuated electrical signal becomes the cause of deterioration in the measurement sensitivity with respect to the change in capacitance generated by contact being made with a human body.

Reference numeral 510d of FIG. 12 indicates a waveform for time and the voltage of an electrical signal line 510d applied from the touch screen control unit 300 in order to measure capacitance, and the amplitude of the voltage corresponds to a level of V0.

Reference numeral 590 indicates the waveform of an electrical signal in which the waveform of the electrical signal, applied from the control unit in order to measure capacitance, is measured at a first point 590 where the touch input of a user was received after passing through a virtual resistor R0. The amplitude of the voltage of the signal, attenuated by low pass filter components including R0−C1−C2 components, corresponds to a voltage level of V1.

Reference numeral 591 indicates the waveform of an electrical signal in which the waveform of the electrical signal, applied from the control unit 300, is measured at a second point 591 where the touch input of a user was received after passing through a virtual resistor R0+R0+R0+R0+R0+R0. The amplitude of the voltage of the signal, attenuated by low pass filter component including (R0+R0+R0+R0+R0+R0)−C2−C0 components, corresponds to a voltage level of V2.

The correlation between the amplitude V0 of the voltage initially sensed using the capacitance touch screen control unit, the amplitude V1 of the voltage measured at the first point of the conductive electrode, and the amplitude V2 of the voltage measured at the second point is represented in the following Equation 1.

V0>V1>V2 (1)

With regard to an electrode pattern used to sense the capacitance of a touch sensor, it can be understood that relative capacitance measurement ability is reduced as the resistance of the electrode pattern increases because of the reduced amplitude of the voltage of the sensed signal. Therefore, in order to reduce the terminating resistance of a corresponding electrode, a pattern which has a wide width should be formed like the second electrode pattern 210 applied to the second electrode layer 200 of the present invention as much as possible, thereby reducing surface resistance (Ω/sq). The terminating resistance, reduced using such a conductive pattern which has wide width, varies the time constant of a low pass filter, so that the phenomenon of the attenuation of the width of an electrical signal decreases, thereby contributing to the capacitance sensing ability compared to the prior art method.

Further, the performance of an electrode itself is improved due to reduced resistance and the electrodes having an increased area using the structure of the second electrode pattern 210, with the result that the value of the capacitance generated by contact being made with a human body is formed greater than the existing capacitance, so that the control unit may have many advantages.

Capacitance is determined based on the first and second electrodes, the dielectric constant between the electrodes, the distance between the two electrodes, and the areas of the two electrodes which face each other. Here, the hand of a human body is assumed to be the first electrode and the electrode pattern of the first or second electrode layer is assumed to be a second electrode. Under the same conditions, the second electrode (having a large capacitance) may ideally operate as the resistance of the second electrode is small. Further, as the resistance is small, the intensity of an electrical signal which is used for sensing and which is transmitted from the control device becomes large, thereby being resistant to noise. Therefore, if the value of capacitance with the human body increases on the touch screen and external noise decreases, there is an advantage in that better performance may be implemented.

The control unit (semiconductor) 300 used to sense the capacitance of the touch screen input apparatus configured as described above is designed to sequentially drive the first electrode patterns and the second electrode patterns as shown in FIG. 15. Voltage at a ground level or a specific voltage is applied to corresponding electrodes (voltage at the ground level is applied in the present embodiment) for electrode patterns other than electrode patterns (each case of S1 and S2) each used to drive an electrical signal in order to measure capacitance, so that it is another principle technical gist of the present invention that can measure capacitance generated by the touch of a user and form a conductive shield film for blocking the inflow of external noise using electrode patterns other than electrode patterns used to sense capacitance.

Here, even when a shield film, to which specific voltage which does not have noise components, is formed, the shield film can sufficiently perform the function of shielding external noise. Therefore, external noise can be shielded if there is a stable supply of a voltage at any level between 0V (ground voltage) and VDD (total supply voltage).

The control unit applied to the present invention uses the Korea Unexamined Patent Publication No. 2007-0095453 applied by the present applicant, so that the control unit has a feature that, even when the amount of current of an electrical signal applied to measure capacitance increases, only the cycles of charging and discharging increase and the measurement sensitivity of capacitance does not decrease according to measurement results for the same time period. The control unit is not limited thereto, and can be controlled using various other measurement methods.

Therefore, when the value of the current of a signal applied to each of the electrode patterns of the first electrode layer 100 and the second electrode layer 200 increases, control is made such that a high sensitivity to changes the in capacitance generated by the contact being made with a human body may be maintained while excellent SNR for external noise which flows into the electrode pattern can be maintained.

The above-described present invention applies ground voltage to electrode patterns in which sensing operations are not generated, with the result that the electrode patterns function as shield films, so that parasitic capacitance or external noise is attenuated, thereby having advantages of a separate shield film not needing to be provided, improving touch sensitivity, and improving productivity and increasing the yield of good product.

Although the description was made and illustrated in conjunction with preferred embodiments for exemplifying the principle of the present invention, the present invention is not limited to the illustrated and described configuration and operation.

Rather, those skilled in the art will appreciate that various modifications and corrections are possible without departing form the sprit and scope of the accompanying claims. Therefore, it should be regarded that those appropriate modifications, corrections and equivalents are included in the scope of the present invention.

1. A touch screen input apparatus, comprising:
a first electrode layer configured to perform sensing in a first direction, and provided with first electrode patterns which are formed on a top surface of a substrate;
a second electrode layer configured to perform sensing in a second direction, provided under the first electrode layer, and provided with second electrode patterns which are formed on a top surface of a substrate such that the second electrode patterns overlap the first electrode patterns through a surface on which the first electrode patterns are not formed, and which are spaced apart from each other by predetermined intervals; and
a control unit configured to control electrode patterns other than electrodes which are used to measure capacitance, from among the first electrode patterns formed on the first electrode layer configured to sense in the first direction and the second electrode patterns formed on the second electrode layer configured to sense the second direction, in a ground state.

2. The touch screen input apparatus as set forth in claim 1, wherein:
the first electrode patterns are formed such that diamond-shaped electrode patterns are connected in the first direction; and
the second electrode patterns are formed in a pole shape such that the second electrode patterns cross the first electrode patterns at right angles, and each of the second electrode patterns are formed to be spaced apart from each other by predetermined intervals.

3. The touch screen input apparatus as set forth in claim 1, the first electrode patterns are formed to have an area which is larger than ½ of an entire area of a touch screen.

4. The touch screen input apparatus as set forth in claim 1, wherein separation areas between the first electrode patterns do not overlap separation areas between the second electrode patterns.

5. The touch screen input apparatus as set forth in claim 1, wherein the control unit applies a ground voltage or a specific voltage to electrodes other than electrodes which perform sensing such that the first electrode layer and the second electrode layer function as shield films.
